(19) United States
(12) Patent Application Publication
(10) Pub. No.: US 2024/0106321 A1
(43) Pub. Date: Mar. 28, 2024

(54) MULTIFUNCTIONAL POWER SUPPLY DEVICE CONTROL SYSTEM

(71) Applicant: Chongqing Keystone International Trade Co., Ltd., Chongqing (CN)

(72) Inventor: SHENG Gao, Chongqing (CN)

(21) Appl. No.: 18/127,014

(22) Filed: Mar. 28, 2023

(30) Foreign Application Priority Data
Sep. 23, 2022 (CN) 2022111781767

(51) Int. Cl. H02M 1/32; H02M 7/44

(52) U.S. Cl. CPC H02M 1/32; H02M 7/44

(57) ABSTRACT

A multifunctional power supply device control system includes a direct-current power circuit, a switching circuit, a low-voltage detection circuit, an interface circuit, an electromagnetic circuit, a DC/AC conversion circuit, a power output circuit, a data acquisition circuit, a data processing circuit, and a master circuit. The direct-current power circuit outputs direct-current power to the low-voltage detection circuit through the switching circuit, and the low-voltage detection circuit outputs direct-current signals to the DC/AC conversion circuit through the interface circuit. The low-voltage detection circuit outputs the direct-current signals to the electromagnetic circuit. The data acquisition circuit collects power information through the DC/AC conversion circuit. The data acquisition circuit transmits the power information to the master circuit through the data processing circuit. The control system supplies power to multiple electrical devices by controlling the interface circuit, which supplies power stably in the interface circuit, improves performance, and is designed with multiple functions.

### TECHNICAL FIELD

The disclosure relates to a field of power supply device, and more particularly to a multifunctional power supply device control system.

### BACKGROUND

With a rapid development of technology, human need a large number of electrical devices for use whether indoor or outdoor activities. All of the electrical devices need a power supply device. Main methods of power supply for the electrical devices in life today includes: 1. using conducting wires to connect interfaces of the electrical devices to the power supply; 2. no conducting wires to connect the interfaces of the electrical devices to the power supply; for example, using wireless electromagnetism to supply power.

The existing power supply device uses a control system to control whether the interfaces are power supplied, which has a lack of reliability of the interface connection when power supplied, thereby resulting in poor interface contact, short circuit, causing arc pulling, overheat and fire catching. And the user needs to adapt at least one conducting wire for each electrical device, which increases purchasing cost.

Moreover, when a wireless interface power supply device is used, there is also a lack of reliability of interface connection, and the power supply device cannot supply power to high-power electrical devices and cannot communicate with the electrical devices.

### SUMMARY

Based on the above description, the disclosure aims to provide a multifunctional power supply device control system to supply power to a variety of electrical devices. Furthermore, the disclosure can stabilize power supply of interfaces by controlling the power supply of the interfaces, improve performance, and have various functions.

In order to achieve the above purposes, the disclosure provides a technical scheme as follows:

A multifunctional power supply device control system includes a direct-current power circuit, a switching circuit, a low-voltage detection circuit, an interface circuit, an electromagnetic circuit, a DC/AC conversion circuit (referred to a mutual conversion of direct current and alternating current), a power output circuit, a data acquisition circuit, a data processing circuit, and a master circuit.

The direct-current power circuit outputs direct-current power to the low-voltage detection circuit through the switching circuit, the low-voltage detection circuit outputs direct-current signals to the DC/AC conversion circuit through the interface circuit and the DC/AC conversion circuit converts the direct-current signals to alternating-current signals and transmits the alternating-current signals to the power output circuit.

The low-voltage detection circuit outputs the direct-current signals to the electromagnetic circuit, which is used to control an electromagnetic adsorption of the interface circuit. The data acquisition circuit collects power signal information through the DC/AC conversion circuit. The data acquisition circuit transmits the collected power signal information to the master circuit through the data processing circuit.

The direct-current power circuit includes a DC/DC circuit (referred to convert the direct current to a constant direct current) and a power management circuit. The direct-current power circuit transmits the direct-current signals to the power management circuit through the DC/DC circuit, and the switching circuit controls the power management circuit.

The DC/DC circuit includes a sampling circuit for collecting the direct-current signals.

The direct-current power circuit further includes a power protection circuit, and the direct-current power circuit transmits the direct-current power to the switching circuit through the power protection circuit.

The interface circuit includes an electromagnetic failure button, which is used to control an electromagnetic failure.

The interface circuit includes an electrical interface female terminal and an electrical interface male terminal, and the electromagnetic failure button is electrically connected to the electrical interface male terminal.

The electromagnetic circuit includes an electromagnetic sheet, which controls whether the electromagnetic sheet adsorbs.

The electromagnetic circuit also includes a contactor and an electromagnet. The electromagnetic circuit controls the electromagnet to adsorb through the contactor.

The power output circuit includes an alternating-current output interface and an alternating-current input interface.

The master circuit includes a display screen, and the master circuit controls the display screen to display information such as the collected power signal information.

The technical scheme of the disclosure has advantages that: 1) the disclosure controls the adsorption through the electromagnetic circuit, uses the adsorption force of the electromagnet to fix the electrical interface, makes the control of the electromagnet and the current transmission cooperate with each other through electronic program to complete the automatic adsorption and fixation of the electrical interface, makes the power supply of the interface circuit more stable and greatly improves the performance of the power supply; 2) the disclosure makes a failure of the electromagnetic adsorption through the electromagnetic failure button, thereby making the interface circuit of the disclosure cannot supply power outside to ensure safety of the power supply of the disclosure; 3) the disclosure supplies power outside through the interface circuit, so that the disclosure possesses functions, such as high-voltage resistance, large-current transmission and communication, cancels using the conducting wires, greatly reduces power consumption and the cost; 4) The disclosure improves automation, is convenient in use and suitable for universal promotion.

### BRIEF DESCRIPTION OF DRAWINGS

FIG. 1 is a system block diagram of a multifunctional power supply device control system according to an embodiment of the disclosure.

FIG. 2 is another system block diagram of the multifunctional power supply device control system according to the embodiment of the disclosure.

FIG. 3 is a flowchart of the multifunctional power supply device control system according to the embodiment of the disclosure.

FIG. 4 is another flowchart of the multifunctional power supply device control system according to the embodiment of the disclosure.

### DETAILED DESCRIPTION OF EMBODIMENTS

The technical schemes of embodiments of the disclosure will be clearly and completely described below in combination with attached drawings in the embodiments of the disclosure. Apparently, the described embodiments are only some of the embodiments of the disclosure and not all of the embodiments of the disclosure. Based on the embodiments of the disclosure, other embodiments obtained by those skilled in the art without creative work belong to the scope of protection of the disclosure.

It needs to be noted that all directional indications (such as up, down, left, right, front, back, etc.) in the embodiments of the disclosure are only used to illustrate the relative position relationship, motion, etc. among components in a specific posture (as shown in the attached drawings). If the specific posture changes, the directional indication will change accordingly.

In the disclosure, unless otherwise specified regulations and limitations, the terms “connect”, “fix”, etc. shall be understood in a broad sense. For example, “fix” may be a fixed connection, a detachable connection, or an integrated connection; it can also be a mechanical connection or an electrical connection; it may be a direct connection or an indirect connection through an intermediate medium; it may be a connection between two components or an interaction between two components, unless otherwise specified limitations. For those skilled in the art, specific meanings of the above terms in the disclosure can be understood according to the specific circumstances.

In addition, if there is a description of “first”, “second”, etc., in the embodiments of the disclosure, the description of “first”, “second”, etc., is only used to describe, cannot be understood as indicating or implying a relative importance or implicitly indicating the number of indicated technical features. Thus, a feature defining “first” or “second” may include at least one of the features explicitly or implicitly. Additionally, the technical schemes of the various embodiments can be combined with each other, but the combination must be based on a realization by those skilled in the art. When the combination of the technical scheme is contradictory or impossible, it should be considered that the combination of such technical scheme does not exist, nor is it within the scope of protection required by the disclosure.

The disclosure is further described in detail below in combination with the attached drawings and the embodiments of the disclosure.

### Embodiment 1

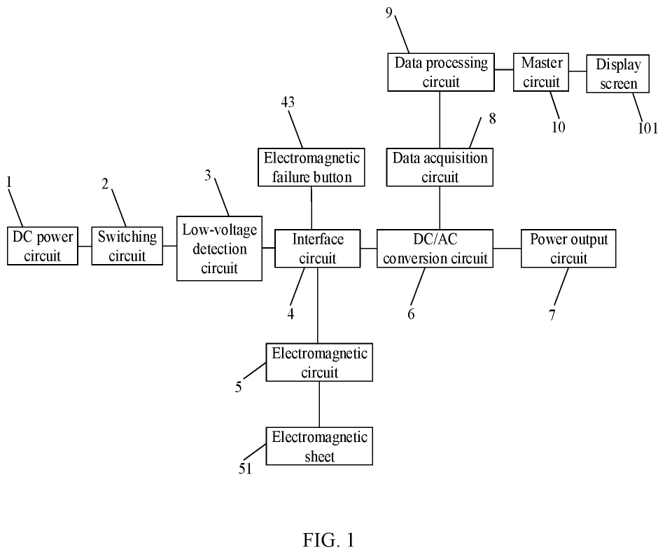

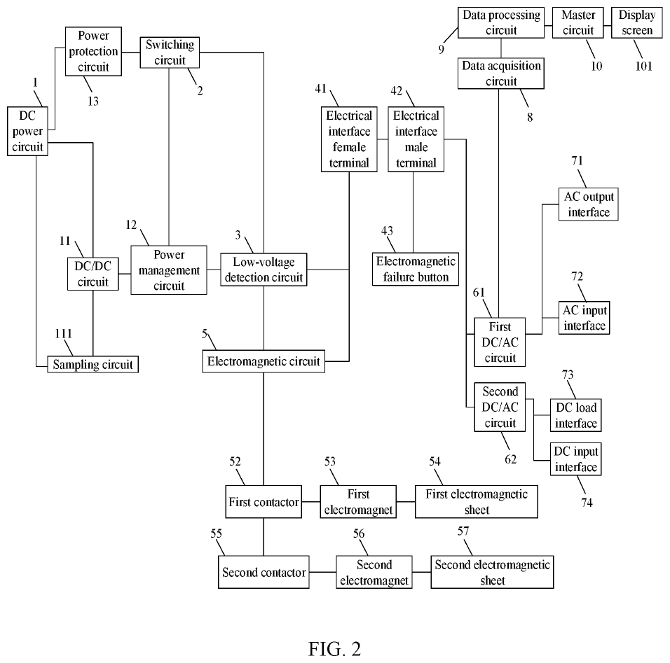

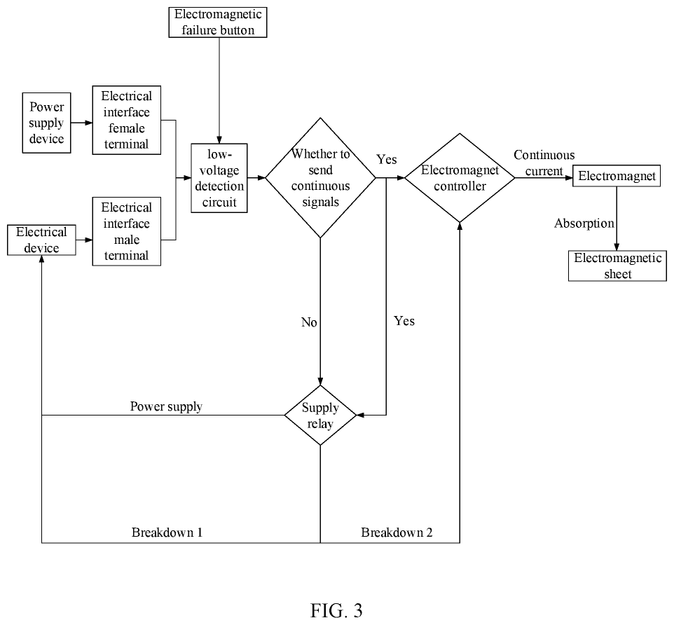

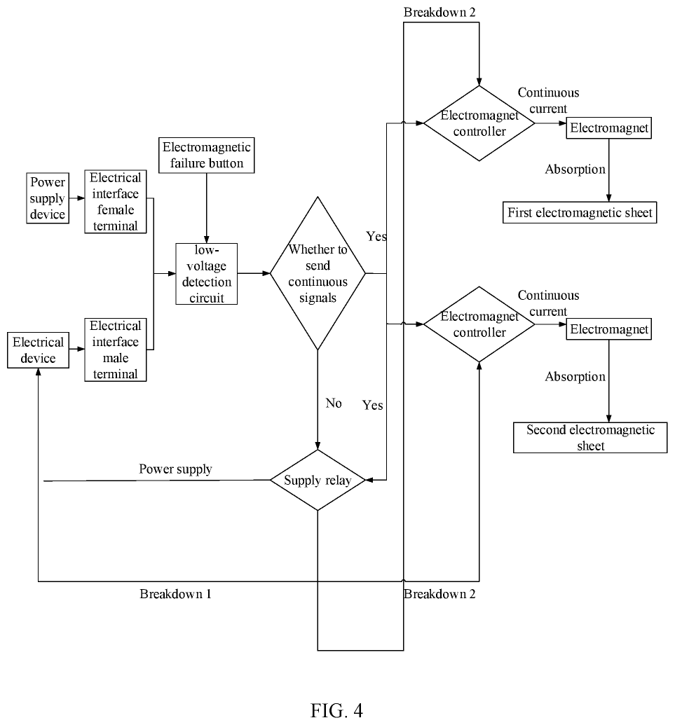

Referring to FIG. 1, FIG. 2, FIG. 3 and FIG. 4, the multifunctional power supply device control system includes a direct-current power circuit 1, a switching circuit 2, a low-voltage detection circuit 3, an interface circuit 4, an electromagnetic circuit 5, a DC/AC conversion circuit 6, a power output circuit 7, a data acquisition circuit 8, a data processing circuit 9, and a master circuit 10.

The direct-current power circuit 1 outputs direct-current power to the low-voltage detection circuit 3 through the switching circuit 2, the low-voltage detection circuit 3 outputs direct-current signals to the DC/AC conversion circuit 6 through the interface circuit 4, and the DC/AC conversion circuit 6 converts the direct-current signals to alternating-current signals and transmits the alternating-current signals to the power output circuit 7.

The low-voltage detection circuit 3 outputs the direct-current signals to the electromagnetic circuit 5, which is used to control an electromagnetic adsorption of the interface circuit 4. The data acquisition circuit 8 collects power signal information through the DC/AC conversion circuit 6. The data acquisition circuit 8 transmits the collected power signal information to the master circuit 10 through the data processing circuit 9.

In an embodiment of the disclosure, the interface circuit 4 is used to control an electrical interface of the disclosure to supply power to electrical devices. The data processing circuit 9 is used for data processing of the collected power signal information. The master control circuit 10 controls and analyzes the power signal information.

In an illustrated embodiment of the disclosure, the electromagnetic circuit 5 further includes an electromagnetic sheet 51.

In the embodiment, the interface circuit 4 is used to supply power to the electrical devices in practical application. However, in the related art, the electrical interface of the power supply device is easy to loosen, which results in defects such as poor effect and poor performance in supplying power to the electrical devices. Therefore, in an illustrated embodiment of the disclosure, the electromagnetic sheet 51 is arranged on the power supply device. The electromagnetic sheet 51 is controlled by the electromagnetic circuit 5 to make the interface circuit 4 connect to the electrical devices more closely through the electrical interface. Using the interface circuit 4 to supply power to the electrical devices is more stable, and greatly improves effects of the power supply device.

In the embodiment, the master circuit 10 can control the collected power signal information for analysis and processing. Once the power signal information is found abnormal, the master circuit 10 can control the interface circuit 4 through the DC/AC conversion circuit to stop supplying power to the electrical devices.

Referring to FIG. 2, in an illustrated embodiment of the disclosure, the direct-current power circuit 1 includes a DC/DC circuit 11 and a power management circuit 12. The direct-current power circuit 1 transmits the direct-current signals to the power management circuit 12 through the DC/DC circuit 11, and the switching circuit 2 controls the power management circuit 12. In some embodiments, the direct-current power circuit 1 includes a supply relay.

In the embodiment, the DC power circuit 1 manages and detects the direct-current power through the power management circuit 12 to ensure an output safety of the direct-current power. The switching circuit 2 controls the power management circuit 12.

In an illustrated embodiment of the disclosure, the DC/DC circuit 11 includes a sampling circuit 111 for collecting the direct-current signals.

In the embodiment, the sampling circuit 111 collects the direct-current signals. Once the direct-current signals are found an abnormality, the DC/DC circuit 11 transmits the abnormality to the power management circuit 12, and the power management circuit 12 processes the abnormality to ensure an output safety of the direct-current power circuit 1.

In the embodiment, the sampling circuit 111 can also collect power information of the direct-current power circuit 1 and transmits the power information to the power management circuit 12 that processes the power information of the direct-current power circuit 1 and ensures the output safety of the direct-current power circuit 1.

In the embodiment, the low-voltage detection circuit 3 transmits detected voltage information to the power management circuit 12. The power management circuit 12 processes the detected voltage information of the low-voltage detection circuit 3. Once an abnormality is found, the power management circuit 12 ensures the output safety of the direct-current power circuit 1.

In an illustrated embodiment of the disclosure, the direct-current power circuit 1 further includes a power protection circuit 13, and the direct-current power circuit 1 transmits the direct-current power to the switching circuit 2 through the power protection circuit 13.

In the embodiment, the power protection circuit 13 is used to protect the direct-current power circuit 1. Once an abnormality is found, the power protection circuit 13 disconnects the direct-current power circuit 1, thereby protecting the direct-current power circuit 1.

### Embodiment 2

Referring to FIG. 1 and FIG. 2, the difference from the above embodiment is that in this embodiment, the interface circuit 4 further includes an electromagnetic failure button 43, which is used to control an electromagnetic failure.

In the embodiment, when an abnormality is found in the interface circuit 4 supplying power to the electrical devices, the electromagnetic failure button 43 can be used to control the electromagnetic circuit 5 to control the electromagnetic adsorption failure, so that the electrical interface of the disclosure is disconnected the electrical devices, and a safety of supplying power in the disclosure is guaranteed.

Referring to FIG. 2, in an illustrated embodiment of the disclosure, the interface circuit 4 includes an electrical interface female terminal 41 and an electrical interface male terminal 42, and the electromagnetic failure button 43 is electrically connected to the electrical interface male terminal 42.

In the embodiment, the electrical interface female terminal 41 can be set in the power supply device of the disclosure, and the electrical interface male terminal 42 can be set on the electrical device. When the power supply device of the disclosure supplies power to the electrical devices, the electrical interface female terminal 41 and the electrical interface male terminal 42 are electrically connected to supply power.

In the embodiment, the electromagnetic circuit 5 controls the electrical interface female terminal 41. When it is abnormal to supply power to the electrical devices, the electromagnetic circuit 5 controls the electrical interface female terminal 41 to disconnect the electrical interface male terminal 42, ensuring the safety of supplying power in the disclosure.

In an illustrated embodiment of the disclosure, the electrical interface male terminal 42 can disconnect the electrical interface female terminal 41 by controlling the electromagnetic failure button 43, which also ensures the safety of supplying power in the disclosure.

In an illustrated embodiment of the disclosure, the electromagnetic circuit 5 further includes a contactor (including an electromagnet controller therein) and an electromagnet. The electromagnetic circuit controls the electromagnet to adsorb through the contactor.

Referring to FIG. 2, when the interface circuit 4 supplies power to one electrical device, the electromagnetic circuit 5 includes a first contactor 52, a first electromagnet 53, and a first electromagnetic sheet 54. The first electromagnet 53 is arranged in the power supply device of the disclosure, and the first electromagnetic sheet 54 is arranged on the one electrical device. When the disclosure supplies power to the one electrical device, the electromagnetic circuit 5 controls the first electromagnet 53 to absorb the first electromagnetic sheet 54 through the first contactor 52, which ensures that the electrical interface of the disclosure is more closely connected to the electrical device, at the same time, the stability of supplying power in the disclosure is guaranteed, and the performance of supplying power in the disclosure can be greatly improved.

When the electromagnetic failure button 43 is pressed, the electromagnetic circuit 5 controls the first contactor 52 to be disconnected, thus separating the first electromagnet 53 from the first electromagnetic sheet 54, thus ensuring the safety of supplying power in the disclosure.

Similarly, when the interface circuit 4 supplies power to multiple electrical devices, the electromagnetic circuit 5 correspondingly includes a plurality of contactors, a plurality of electromagnets, and a plurality of electromagnetic sheets to supply power. In the embodiment, when the interface circuit 4 supplies power to two electrical devices, the electromagnetic circuit 5 includes a first contactor 52 and a second contactor 55; a first electromagnet 53 and a second electromagnet 56; a first electromagnetic sheet 54 and a second electromagnetic sheet 57. The electromagnetic circuit 5 controls the first contactor 52, the first electromagnet 53 and the first electromagnetic sheet 54 and the second contactor 55, the second electromagnet 56 and the second electromagnetic sheet 57 respectively.

Starting logic of the electromagnetic circuit 5:

As shown in FIG. 1 to FIG. 4, the low-voltage detection circuit 3 starts to work only after that the power supply device of the disclosure is connected to an electrical interface of the electrical device. The low-voltage detection circuit 3 monitors an integrality of a high-voltage loop through low-voltage signals, checks components connected to high-voltage wires on the power supply device and the electrical device of the disclosure through the low-voltage signals and detects electrical connection integrity and continuity of each high-voltage system loop, which achieves high-low voltage interlock. The low-voltage detection circuit 3 detects to identify parameters of the low-voltage detection circuit, including but not limited to fixed current, current pulse frequency etc. When the high voltage and large current conditions are met, the low-voltage detection circuit sends continuous start signals to the electromagnet controller (i.e., the electromagnetic circuit), and then the electromagnet controller provides a continuous current to the electromagnet to generate magnetic attraction and adsorb the magnetic materials at the electrical device to realize a fixed limit of the direct-current electrical interface in a Y direction, and enhance connection reliability of the electrical interface of the disclosure. After the low-voltage detection circuit 3 sends the continuous start signals to the electromagnetic circuit 5, and after the electromagnet has completed the adsorption within the set time interval, the low-voltage detection circuit 3 sends the continuous start signals to the switching circuit 2 to make the switching circuit 2 be closed, thereby enabling the direct-current power circuit 1 to supply power to the electrical device.

Disconnection logic of a looseness of the electrical interface of the disclosure:

When the power supply device of the disclosure supplies power to the electrical device, if the electrical interface is loose (i.e., the connection between the power supply device and the electrical device is loose), the low-voltage detection circuit 3 will be disconnected, and the low-voltage detection circuit 3 cannot recognize the parameters of the low-voltage detection loop, including but not limited to the fixed current, the current pulse frequency, etc., that is, the low-voltage detection circuit 3 cannot send the continuous start signals to the electromagnetic circuit 5 and the switching circuit 2. At this time, the switching circuit 2 first stops supplying power to the electrical device, and then the electromagnetic circuit 5 stops supplying continuous current for the electromagnet to realize demagnetization of the electromagnet and separation from the electrical device. The adsorption capacity of the electromagnet is designed according to the quality of the electrical device to be adsorbed.

Control logic of the electromagnetic failure button 43: The electrical interface male terminal 42 at one side of the electrical device of the disclosure is provided with the electromagnetic failure button 43. Pressing the electromagnet failure button 43 will directly cut off the low-voltage detection circuit 3, making the low-voltage detection circuit 3 unable to recognize the low-voltage detection circuit, including but not limited to the fixed current size, current pulse frequency, etc., that is, the low-voltage detection circuit 3 cannot send the continuous start signals to the electromagnet controller and the switching circuit 2. At this time, the switching circuit 2 first stops supplying power to the electrical device, and then the electromagnetic circuit 5 stops supplying continuous current to the electromagnet to realize demagnetization of the electromagnet and separation from the electrical device.

In an illustrated embodiment of the disclosure, the DC/AC conversion circuit 5 includes a first DC/AC conversion circuit 61 and a second DC/AC conversion circuit 62. The first DC/AC conversion circuit 61 and the second DC/AC conversion circuit 62 belong to a dual conversion circuit, that is, the DC/AC conversion circuit can realize a mutual conversion of direct current and alternating current.

In an illustrated embodiment of the disclosure, the power output circuit 7 includes an alternating-current output interface 71 and an alternating-current input interface 72.

In the embodiment of the disclosure, the alternating-current output interface 71 converts the direct-current signals to the alternating-current signals through the first DC/AC conversion circuit 61, so that the alternating-current output interface 71 outputs the alternating-current signals.

In the embodiment of the disclosure, the alternating-current input interface 72 outputs the alternating-current signals to convert the alternating current to the direct current through the first DC/AC conversion circuit 61 to charge the DC power circuit 1.

In the embodiment of the disclosure, the second DC/AC conversion circuit 62 includes a direct-current load interface 73 and a direct-current input interface 74. The direct-current load interface 73 is used for external direct-current load. The direct-current input interface 74 is used to output the direct-current signals to charge the direct-current power circuit 1.

In an illustrated embodiment of the disclosure, the master circuit 10 includes a display screen 101. The master circuit 10 controls the display screen 101 to display the power signal information. The display screen 101 displays the power signal information controlled and analyzed by the master circuit 10.

The electrical interface controlled by the interface circuit 4 of the disclosure can resist high voltage; transmit large current and realize communication, which can cancel the use of conducting wires. The electrical interface of the disclosure should possess high-low voltage interlock function, and compared with the high-voltage circuit, the low-voltage detection circuit should be connected first and then disconnected later within a certain time interval. For the electrical interface, the low-voltage detection circuit has a certain control logic relationship with the high-voltage circuit and the connection and disconnection of the electromagnet. The electrical interface can be adjusted according to the actual needs. The functions that can be realized by the electrical interface include but are not limited to information communication such as voltage request, working current, fault information, residual power, and temperature. When the electrical device with multiple electrical interfaces is in use, only one electrical interface is to be powered on. When the electrical device with multiple electrical interfaces is powered on, all of the electromagnets need to be started to fix the electrical device, which is realized by each electrical interface of the electrical device with multiple electrical interfaces performs the low-voltage detection to ensure whether the low-voltage detection circuit is powered on. When the low-voltage detection circuit is powered on, the electromagnet of the electrical interface is started, and all the electromagnets are started accordingly. Therefore, the direct-current power circuit 1 provides power for the electrical device.

The above descriptions are only some of the illustrated embodiments of the disclosure, not used to limit the scope of the protection of the disclosure.

What is claimed is:

1. A power supply device control system, comprising:
a direct-current power circuit, a switching circuit, a low-voltage detection circuit, an interface circuit, an electromagnetic circuit, a direct current (DC)/alternating circuit (AC) conversion circuit, a power output circuit, a data acquisition circuit, a data processing circuit, and a master circuit;
wherein the direct-current power circuit is configured to output direct-current power to the low-voltage detection circuit through the switching circuit, the low-voltage detection circuit is configured to output direct-current signals to the DC/AC conversion circuit through the interface circuit, and the DC/AC conversion circuit is configured to convert the direct-current signals to alternating-current signals and transmit the alternating-current signals to the power output circuit; and
wherein the low-voltage detection circuit is configured to output the direct-current signals to the electromagnetic circuit; the electromagnetic circuit is configured to control the interface circuit to generate an electromagnetic adsorption;
the data acquisition circuit is configured to collect power signal information through the DC/AC conversion circuit and transmit the collected power signal information to the master circuit through the data processing circuit.

2. The power supply device control system according to claim 1, wherein the direct-current power is provided with: a DC/DC circuit and a power management circuit; the direct-current power circuit is configured to transmit the direct-current signals to the power management circuit through the DC/DC circuit, and the switching circuit is configured to control the power management circuit.

3. The power supply device control system according to claim 2, wherein the DC/DC circuit is provided with a sampling circuit configured to collect the direct-current signals.

4. The power supply device control system according to claim 3, wherein the direct-current power is further provided with: a power protection circuit, the direct-current power circuit is configured to transmit the direct-current power to the switching circuit through the power protection circuit.

5. The power supply device control system according to claim 1, wherein the interface circuit is provided with an electromagnetic failure button configured to control an electromagnetic failure.

6. The power supply device control system according to claim 5, wherein the interface circuit is further provided with: an electrical interface female terminal and an electrical interface male terminal configured to electrically connect to the electromagnetic failure button.

7. The power supply device control system according to claim 6, wherein the electromagnetic circuit is provided with an electromagnetic sheet, the electromagnetic circuit is configured to control the electromagnetic sheet for adsorption.

8. The power supply device control system according to claim 7, wherein the electromagnetic circuit is further provided with a contactor and an electromagnet; the electromagnetic circuit is configured to control the electromagnet for adsorption through the contactor.

9. The power supply device control system according to claim 8, wherein the power output circuit comprises: an alternating-current output interface and an alternating-current input interface.

10. The power supply device control system according to claim 9, wherein the master circuit comprises: a display screen; the master circuit is configured to control the display screen to display information.

11. A power supply device control system, comprising: a direct-current power circuit, a power management circuit, a power protection circuit, a switching circuit, a low-voltage detection circuit, an interface circuit, and an electromagnetic circuit;
wherein the direct-current power circuit is configured to transmit direct-current power to the switching circuit through the power protection circuit;
the low-voltage detection circuit is configured to detect an integrality of high-voltage loop, and in response to the integrality of high-voltage loop meeting a preset condition, send a first start signal to the electromagnetic circuit and send a second start signal to the switching circuit through the power management circuit;
the electromagnetic circuit is configured to generate an electromagnetic adsorption to control the interface circuit based on the first start signal;
the switching circuit is configured to transmit the direct-current power to the low-voltage detection circuit in response to receiving the second start signal; and
the low-voltage detection circuit is configured to output the direct-current power to the interface circuit for supplying power to an electrical device;
the interface circuit is provided with an electromagnetic failure button, configured to control the electromagnetic adsorption failure.
